(19) United States
(12) Patent Application Publication
(10) Pub. No.: US 2012/0196623 A1
(43) Pub. Date: Aug. 2, 2012

(54) SYSTEMS AND METHODS FOR MEASURING INCLINCATION OF SLOPES WITH RESPECT TO FIXED DIRECTIONS

(75) Inventor: YAT WAI EDWIN KWONG, HONG KONG (HK)

(73) Assignee: HORIZONTAL VERITICAL LIMITED, HONG KONG (HK)

(21) Appl. No.: 13/015,862

(22) Filed: Jan. 28, 2011

(51) Int. Cl. H04W 4/02

(52) U.S. Cl. 455/456.3

(57) ABSTRACT

Systems and methods are provided for measuring inclination of slopes given their locations with respect to fixed directions. One embodiment includes a system for measuring inclination of slopes given their locations with respect to fixed directions. The system further includes using modules including accelerometers, compassing devices, and mobile phones. The disclosed accelerometers are configured to measure an angle of orientation, wherein the angle represents the current angle of orientation the mobile phone with respect to gravity. Also, the compassing device is configured to detect current direction of which the mobile phone is oriented, with respect to earth's North Pole.

### BACKGROUND

I. Technical Field

The present invention generally relates to systems and methods for measuring inclination of slopes given their locations with respect to fixed directions. Specifically, and without limitation, the invention relates to systems and methods for measuring inclination of slopes using modules including accelerometers, compassing devices, and mobile phones.

II. Background Information

A slope refers to the amount of inclination of a surface above the ground level. Some slopes are slanted at a fraction of a degree. However, other slopes at slanted at a large degree and can become very dangerous for cars, bicycle, and even pedestrians. For example, determining how slopes are slanted plays a key role in road construction. Prior to any construction activities, the slope information with respect to the entire examined area must be examined thoroughly. This is currently accomplished by using big, expensive machines, which proved to be extremely exhaustive and at times ineffective, especially considering the huge power consumption. Therefore, measuring tools to detect and report slopes of any locations that are cost effective is highly valuable. Moreover, there are professions that are required to record how slopes are slanted of a given location. Such professionals include surveyors, and these individuals would find a tool handy if the tool can detect useful characteristics of a slope.

In view of the foregoing, there is a need for systems and methods that can provide simple solutions to measure inclination of slopes in cost effective manners. There is also a need for systems and methods that can measure inclination of slopes given the locations with respect to fixed directions of the measuring devices that are employed.

### SUMMARY

Embodiments of the present invention relates to methods and systems for measuring inclination of slopes given their locations with respect to fixed directions. Consistent with embodiments of the invention, a central system is included. The system manages maps including information of slope inclination of a given area.

In addition, a mobile phone may be included in the embodiments, which comprises a lower housing that allows the mobile phone standing without human support. Further, the embodiments may comprise a location detection device. The location detection device may be included within the mobile phone. More, the location detection device may detect current location of the mobile phone.

The embodiments may further comprise an accelerometer device within the mobile phone. The accelerometer device may be configured to measure an angle of orientation. The angle of orientation may represent the current angle of orientation the mobile phone with respect to gravity.

Further, a compassing device may be provided. The compassing device may be physically included within the mobile phone, wherein the compassing device is configured to detect current direction of which the mobile phone is oriented, with respect to earth's North Pole.

Embodiments further include a map that is installed within the mobile phone. According to the embodiments, the map may configured to construct inclination of slopes given their locations with respect to fixed directions. In the embodiments, the mobile phone may include a processor and a memory. A memory is included in the mobile phone that stores instructions that are executed by the processor to perform a method.

In one embodiment, the method comprises measuring inclination of the slope by placing the mobile phone on the lower housing that is sitting on a slope, wherein the slope is slanted at a slanted angle with respect to earth horizon; using the accelerometer device to report a reading providing the current angle of orientation of the mobile phone with respect to the gravity, wherein the current angle of orientation is used to represent the slanted angle of the slope.

The embodiment may be configured to comprise steps including using the compassing device to report a reading providing current direction of the mobile phone, wherein the current direction of the mobile phone is used to represent the direction where the slope is slanted at; using the location detection device to detect a reading providing the current location of the mobile phone; combining the reading by accelerometer device, the reading by the compassing device, and the reading by the location detection device, in order to form an attribute to represent inclination of the slope of the current location.

Further, in the embodiment, in order to report the inclination of the slope of the current location, sending the reading by accelerometer device, the reading by the compassing device, and the reading by the location detection device to the central system. After the central system receives the reading by accelerometer device, the reading by the compassing device, and the reading by the location detection device to the central system, the central system adds the readings to a map of the given area in relation to the current location. After the central system completes adding the readings to the map, the central system may then send the map to the mobile phone when the mobile phone requests for receiving the map.

It is to be understood that both the foregoing general description and the following detailed description are exemplary and explanatory only, and are not restrictive of the scope of the invention, described and as claimed. Furthermore, features and variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram illustrating a system for measuring inclination of slopes, consistent with an embodiment of the invention.

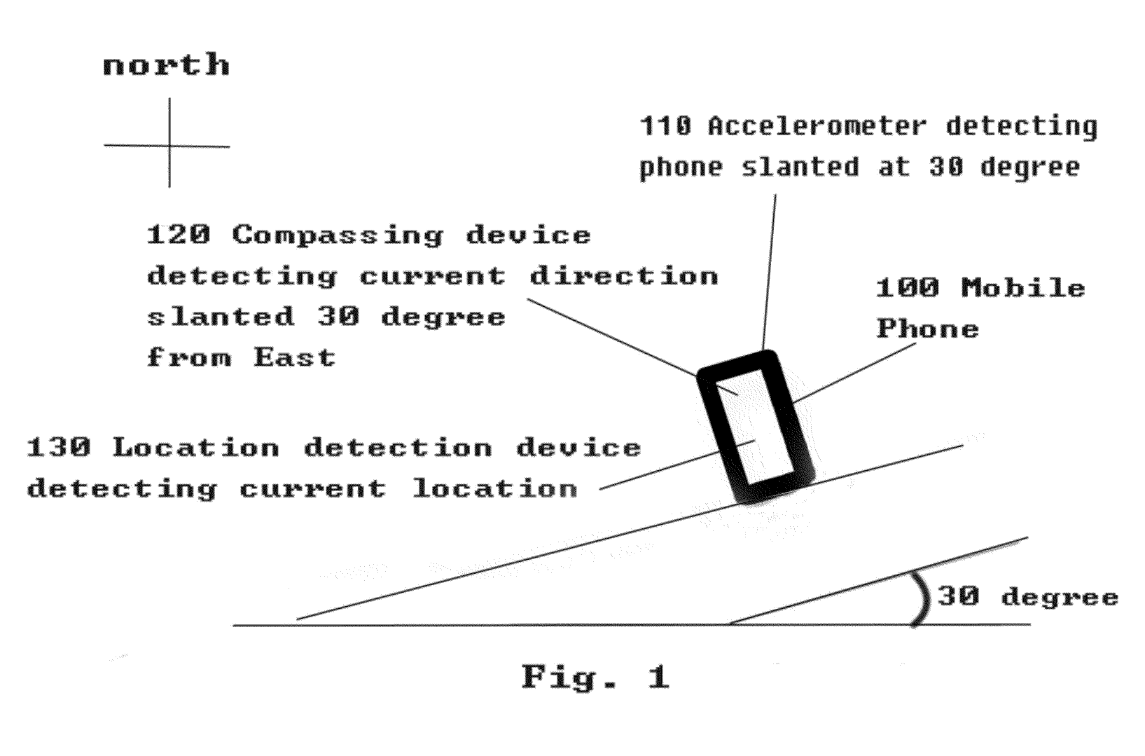

### DETAILED DESCRIPTION

Embodiments of the present invention include a system for measuring inclination of slopes given their locations with respect to fixed directions, comprising a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, wherein the accelerometer device 110 is configured to measure an angle of orientation, wherein the angle represents the current angle of orientation the mobile phone 100 with respect to gravity; a compassing device 120 within the mobile phone 100, wherein the compassing device 120 is configured to detect current direction of which the mobile phone 100 is oriented, with respect to earth's North Pole.

In the system, a map within the mobile phone 100 is included. The map is configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity, wherein the current angle of orientation is used to represent the slanted angle of the slope; using the compassing device 120 to report a reading providing current direction of the mobile phone 100.

The current direction of the mobile phone 100 may be used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system, wherein after the central system receives the reading by accelerometer device 110, the reading by the compassing device 120, and the reading by the location detection device 130 to the central system, the central system adds the readings to a map of the given area in relation to the current location; after the central system completes adding the readings to the map, the central system sends the map to the mobile phone 100 when the mobile phone 100 requests for receiving the map; and searching for the current direction and the degree of inclination of the slope of current location by the user using the mobile phone 100 at a later time, by referring to the map received from the central system, wherein the mobile phone 100 is being placed at a location away from the current location.

In one implementation, a system is provided to measure inclination of slopes given their locations with respect to fixed directions. The system comprises a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, where in the accelerometer device 110 is configured to measure an angle of orientation, wherein the angle represents the current angle of orientation the mobile phone 100 with respect to gravity; a compassing device 120 within the mobile phone 100, wherein the compassing device 120 is configured to detect current direction of which the mobile phone 100 is oriented, with respect to earth's North Pole; a map within the mobile phone 100, wherein the map is configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity.

The current angle of orientation may be used to represent the slanted angle of the slope; using the compassing device 120 to report a reading providing current direction of the mobile phone 100, wherein the current direction of the mobile phone 100 is used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system.

After the central system receives the reading by accelerometer device 110, the reading by the compassing device 120, and the reading by the location detection device 130 to the central system, the central system adds the readings to a map of the given area in relation to the current location; after the central system completes adding the readings to the map, the central system sends the map to the mobile phone 100 when the mobile phone 100 requests for receiving the map; searching for the current direction and the degree of inclination of the slope of current location by the user using the mobile phone 100 at a later time, by referring to the map received from the central system, wherein the mobile phone 100 is being placed at a location away from the current location; and a separate GPS device that is configured to report inclination of slopes of current positions, wherein the central system sends the map to the GPS device when a user of the GPS device requests for receiving the map; and the GPS device searches for the current direction and the degree of inclination of the slope of current location by the user using the separate GPS device, by referring to the map received from the central system, wherein the GPS device is being placed at the current location.

In another implementation, a system is provided, which comprises a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, where in the accelerometer device 110 is configured to measure an angle of orientation, wherein the angle represents the current angle of orientation the mobile phone 100 with respect to gravity; a compassing device 120 within the mobile phone 100, wherein the compassing device 120 is configured to detect current direction of which the mobile phone 100 is oriented, with respect to earth's North Pole; a map within the mobile phone 100.

The map may be configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity, wherein the current angle of orientation is used to represent the slanted angle of the slope; using the compassing device 120 to report a reading providing current direction of the mobile phone 100, wherein the current direction of the mobile phone 100 is used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system.

After the central system receives the reading by accelerometer device 110, the reading by the compassing device 120, and the reading by the location detection device 130 to the central system, the central system adds the readings to a map of the given area in relation to the current location; after the central system completes adding the readings to the map, the central system sends the map to the mobile phone 100 when the mobile phone 100 requests for receiving the map; searching for the current direction and the degree of inclination of the slope of current location by the user using the mobile phone 100 at a later time, by referring to the map received from the central system, wherein the mobile phone 100 is being placed at a location away from the current location; a separate GPS device that is configured to report inclination of slopes of current positions, wherein the central system sends the map to the GPS device when a user of the GPS device requests for receiving the map; and the GPS device searches for the current direction and the degree of inclination of the slope of current location by the user using the separate GPS device, by referring to the map received from the central system, wherein the GPS device is being placed at the current location; and a correcting unit within the mobile phone 100, wherein the correcting unit corrects any wrong information of the map received from the central system, when the mobile phone 100 detects a different result from the map.

Further, in yet another example, a system may be provided for measuring inclination of slopes given their locations with respect to fixed directions. In which case, the system may comprise a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, where in the accelerometer device 110 is configured to measure an angle of orientation, wherein the angle represents the current angle of orientation the mobile phone 100 with respect to gravity; a compassing device 120 within the mobile phone 100.

The compassing device 120 may be configured to detect current direction of which the mobile phone 100 is oriented, with respect to earth's North Pole; a map within the mobile phone 100, wherein the map is configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity.

The current angle of orientation is used to represent the slanted angle of the slope; using the compassing device 120 to report a reading providing current direction of the mobile phone 100, wherein the current direction of the mobile phone 100 is used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system, wherein after the central system receives the reading by accelerometer device 110, the reading by the compassing device 120, and the reading by the location detection device 130 to the central system, the central system adds the readings to a map of the given area in relation to the current location.

After the central system completes adding the readings to the map, the central system sends the map to the mobile phone 100 when the mobile phone 100 requests for receiving the map; searching for the current direction and the degree of inclination of the slope of current location by the user using the mobile phone 100 at a later time, by referring to the map received from the central system, wherein the mobile phone 100 is being placed at a location away from the current location; a separate GPS device that is configured to report inclination of slopes of current positions, wherein the central system sends the map to the GPS device when a user of the GPS device requests for receiving the map; and the GPS device searches for the current direction and the degree of inclination of the slope of current location by the user using the separate GPS device, by referring to the map received from the central system, wherein the GPS device is being placed at the current location; and a correcting unit within the mobile phone 100, wherein the correcting unit corrects any wrong information of the map received from the central system, when the mobile phone 100 detects a different result from the map; and wherein any wrong information is detected, the correcting unit sends the different result to the central system to dispute the wrong location.

Implementation of the present invention should not be limited to systems but also methods. In one implementation, a computer-implemented method is disclosed, which comprises sending, by the central system, the map to a GPS device when a user of the GPS device requests for receiving the map. The method further comprises searching, by the GPS device, for the current direction and the degree of inclination of the slope of current location by the user using the separate GPS device, by referring to the map received from the central system, wherein the GPS device is being placed at the current location.

Likewise, other representations of the invention, such as computer-readable storage medium, can be deployed in the present invention. In one example, a computer-readable storage medium may include steps executable on such storage medium, which include sending, by the central system, the map to a GPS device when a user of the GPS device requests for receiving the map. The method further comprises searching, by the GPS device, for the current direction and the degree of inclination of the slope of current location by the user using the separate GPS device, by referring to the map received from the central system, wherein the GPS device is being placed at the current location. The steps may further comprise correcting, by a correcting unit, wrong information of the map received from the central system, when the mobile phone 100 detects a different result from the map.

The above method steps according to embodiments of the invention may be performed by a programmable processor executing a program of instructions to perform functions or steps of the methods by operating based on input data, and by generating output data. Embodiments of the invention may also be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, or in assembly or machine code. The language or code can be a compiled or interpreted language or code. Processors may include general and special purpose microprocessors. A processor receives instructions and data from memories, in particular from read-only memories or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in application-specific integrated circuits (ASICs).

To provide for interaction with a user, aspects of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Although illustrative embodiments have been described herein with reference to the accompanying drawings, it is noted that the invention is not limited to the precise system and method embodiments described herein, and that various other changes and modifications may be affected by one skilled in the art without departing from the scope or spirit of the invention. All such changes and modifications are intended to be included within the scope of the invention as defined by the appended claims. Embodiments of the present invention include a system for measuring inclination of slopes given their locations with respect to fixed directions, comprising a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, wherein the accelerometer device 110 is configured to measure an angle of orientation, wherein the angle represents the current angle of orientation the mobile phone 100 with respect to gravity; a compassing device 120 within the mobile phone 100, wherein the compassing device 120 is configured to detect current direction of which the mobile phone 100 is oriented, with respect to earth's North Pole.

In the system, a map within the mobile phone 100 is included. The map is configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity, wherein the current angle of orientation is used to represent the slanted angle of the slope; using the compassing device 120 to report a reading providing current direction of the mobile phone 100.

The current direction of the mobile phone 100 may be used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system, wherein after the central system receives the reading by accelerometer device 110, the reading by the compassing device 120, and the reading by the location detection device 130 to the central system, the central system adds the readings to a map of the given area in relation to the current location; after the central system completes adding the readings to the map, the central system sends the map to the mobile phone 100 when the mobile phone 100 requests for receiving the map; and searching for the current direction and the degree of inclination of the slope of current location by the user using the mobile phone 100 at a later time, by referring to the map received from the central system, wherein the mobile phone 100 is being placed at a location away from the current location.

In one implementation, a system is provided to measure inclination of slopes given their locations with respect to fixed directions. The system comprises a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, where in the accelerometer device 110 is configured to measure an angle of orientation, wherein the angle represents the current angle of orientation the mobile phone 100 with respect to gravity; a compassing device 120 within the mobile phone 100, wherein the compassing device 120 is configured to detect current direction of which the mobile phone 100 is oriented, with respect to earth's North Pole; a map within the mobile phone 100, wherein the map is configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity.

The current angle of orientation may be used to represent the slanted angle of the slope; using the compassing device 120 to report a reading providing current direction of the mobile phone 100, wherein the current direction of the mobile phone 100 is used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system.

After the central system receives the reading by accelerometer device 110, the reading by the compassing device 120, and the reading by the location detection device 130 to the central system, the central system adds the readings to a map of the given area in relation to the current location; after the central system completes adding the readings to the map, the central system sends the map to the mobile phone 100 when the mobile phone 100 requests for receiving the map; searching for the current direction and the degree of inclination of the slope of current location by the user using the mobile phone 100 at a later time, by referring to the map received from the central system, wherein the mobile phone 100 is being placed at a location away from the current location; and a separate GPS device that is configured to report inclination of slopes of current positions, wherein the central system sends the map to the GPS device when a user of the GPS device requests for receiving the map; and the GPS device searches for the current direction and the degree of inclination of the slope of current location by the user using the separate GPS device, by referring to the map received from the central system, wherein the GPS device is being placed at the current location.

In another implementation, a system is provided, which comprises a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, where in the accelerometer device 110 is configured to measure an angle of orientation, wherein the angle represents the current angle of orientation the mobile phone 100 with respect to gravity; a compassing device 120 within the mobile phone 100, wherein the compassing device 120 is configured to detect current direction of which the mobile phone 100 is oriented, with respect to earth's North Pole; a map within the mobile phone 100.

The map may be configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity, wherein the current angle of orientation is used to represent the slanted angle of the slope; using the compassing device 120 to report a reading providing current direction of the mobile phone 100, wherein the current direction of the mobile phone 100 is used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system.

After the central system receives the reading by accelerometer device 110, the reading by the compassing device 120, and the reading by the location detection device 130 to the central system, the central system adds the readings to a map of the given area in relation to the current location; after the central system completes adding the readings to the map, the central system sends the map to the mobile phone 100 when the mobile phone 100 requests for receiving the map; searching for the current direction and the degree of inclination of the slope of current location by the user using the mobile phone 100 at a later time, by referring to the map received from the central system, wherein the mobile phone 100 is being placed at a location away from the current location; a separate GPS device that is configured to report inclination of slopes of current positions, wherein the central system sends the map to the GPS device when a user of the GPS device requests for receiving the map; and the GPS device searches for the current direction and the degree of inclination of the slope of current location by the user using the separate GPS device, by referring to the map received from the central system, wherein the GPS device is being placed at the current location; and a correcting unit within the mobile phone 100, wherein the correcting unit corrects any wrong information of the map received from the central system, when the mobile phone 100 detects a different result from the map.

Further, in yet another example, a system may be provided for measuring inclination of slopes given their locations with respect to fixed directions. In which case, the system may comprise a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, where in the accelerometer device 110 is configured to measure an angle of orientation, wherein the angle represents the current angle of orientation the mobile phone 100 with respect to gravity; a compassing device 120 within the mobile phone 100.

The compassing device 120 may be configured to detect current direction of which the mobile phone 100 is oriented, with respect to earth's North Pole; a map within the mobile phone 100, wherein the map is configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity.

The current angle of orientation is used to represent the slanted angle of the slope; using the compassing device 120 to report a reading providing current direction of the mobile phone 100, wherein the current direction of the mobile phone 100 is used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system, wherein after the central system receives the reading by accelerometer device 110, the reading by the compassing device 120, and the reading by the location detection device 130 to the central system, the central system adds the readings to a map of the given area in relation to the current location.

After the central system completes adding the readings to the map, the central system sends the map to the mobile phone 100 when the mobile phone 100 requests for receiving the map; searching for the current direction and the degree of inclination of the slope of current location by the user using the mobile phone 100 at a later time, by referring to the map received from the central system, wherein the mobile phone 100 is being placed at a location away from the current location; a separate GPS device that is configured to report inclination of slopes of current positions, wherein the central system sends the map to the GPS device when a user of the GPS device requests for receiving the map; and the GPS device searches for the current direction and the degree of inclination of the slope of current location by the user using the separate GPS device, by referring to the map received from the central system, wherein the GPS device is being placed at the current location; and a correcting unit within the mobile phone 100, wherein the correcting unit corrects any wrong information of the map received from the central system, when the mobile phone 100 detects a different result from the map; and wherein any wrong information is detected, the correcting unit sends the different result to the central system to dispute the wrong location.

Implementation of the present invention should not be limited to systems but also methods. In one implementation, a computer-implemented method is disclosed, which comprises sending, by the central system, the map to a GPS device when a user of the GPS device requests for receiving the map. The method further comprises searching, by the GPS device, for the current direction and the degree of inclination of the slope of current location by the user using the separate GPS device, by referring to the map received from the central system, wherein the GPS device is being placed at the current location.

Likewise, other representations of the invention, such as computer-readable storage medium, can be deployed in the present invention. In one example, a computer-readable storage medium may include steps executable on such storage medium, which include sending, by the central system, the map to a GPS device when a user of the GPS device requests for receiving the map. The method further comprises searching, by the GPS device, for the current direction and the degree of inclination of the slope of current location by the user using the separate GPS device, by referring to the map received from the central system, wherein the GPS device is being placed at the current location. The steps may further comprise correcting, by a correcting unit, wrong information of the map received from the central system, when the mobile phone 100 detects a different result from the map.

The above method steps according to embodiments of the invention may be performed by a programmable processor executing a program of instructions to perform functions or steps of the methods by operating based on input data, and by generating output data. Embodiments of the invention may also be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, or in assembly or machine code. The language or code can be a compiled or interpreted language or code. Processors may include general and special purpose microprocessors. A processor receives instructions and data from memories, in particular from read-only memories or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in application-specific integrated circuits (ASICs).

To provide for interaction with a user, aspects of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Although illustrative embodiments have been described herein with reference to the accompanying drawings, it is noted that the invention is not limited to the precise system and method embodiments described herein, and that various other changes and modifications may be affected by one skilled in the art without departing from the scope or spirit of the invention. All such changes and modifications are intended to be included within the scope of the invention as defined by the appended claims. Embodiments of the present invention include a system for measuring inclination of slopes given their locations with respect to fixed directions, comprising a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, wherein the accelerometer device 110 is configured to measure an angle of orientation, wherein the angle represents the current angle of orientation the mobile phone 100 with respect to gravity; a compassing device 120 within the mobile phone 100, wherein the compassing device 120 is configured to detect current direction of which the mobile phone 100 is oriented, with respect to earth's North Pole.

In the system, a map within the mobile phone 100 is included. The map is configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity, wherein the current angle of orientation is used to represent the slanted angle of the slope; using the compassing device 120 to report a reading providing current direction of the mobile phone 100.

The current direction of the mobile phone 100 may be used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system, wherein after the central system receives the reading by accelerometer device 110, the reading by the compassing device 120, and the reading by the location detection device 130 to the central system, the central system adds the readings to a map of the given area in relation to the current location; after the central system completes adding the readings to the map, the central system sends the map to the mobile phone 100 when the mobile phone 100 requests for receiving the map; and searching for the current direction and the degree of inclination of the slope of current location by the user using the mobile phone 100 at a later time, by referring to the map received from the central system, wherein the mobile phone 100 is being placed at a location away from the current location.

In one implementation, a system is provided to measure inclination of slopes given their locations with respect to fixed directions. The system comprises a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, where in the accelerometer device 110 is configured to measure an angle of orientation, wherein the angle represents the current angle of orientation the mobile phone 100 with respect to gravity; a compassing device 120 within the mobile phone 100, wherein the compassing device 120 is configured to detect current direction of which the mobile phone 100 is oriented, with respect to earth's North Pole; a map within the mobile phone 100, wherein the map is configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity.

The current angle of orientation may be used to represent the slanted angle of the slope; using the compassing device 120 to report a reading providing current direction of the mobile phone 100, wherein the current direction of the mobile phone 100 is used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system.

After the central system receives the reading by accelerometer device 110, the reading by the compassing device 120, and the reading by the location detection device 130 to the central system, the central system adds the readings to a map of the given area in relation to the current location; after the central system completes adding the readings to the map, the central system sends the map to the mobile phone 100 when the mobile phone 100 requests for receiving the map; searching for the current direction and the degree of inclination of the slope of current location by the user using the mobile phone 100 at a later time, by referring to the map received from the central system, wherein the mobile phone 100 is being placed at a location away from the current location; and a separate GPS device that is configured to report inclination of slopes of current positions, wherein the central system sends the map to the GPS device when a user of the GPS device requests for receiving the map; and the GPS device searches for the current direction and the degree of inclination of the slope of current location by the user using the separate GPS device, by referring to the map received from the central system, wherein the GPS device is being placed at the current location.

In another implementation, a system is provided, which comprises a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, where in the accelerometer device 110 is configured to measure an angle of orientation, wherein the angle represents the current angle of orientation the mobile phone 100 with respect to gravity; a compassing device 120 within the mobile phone 100, wherein the compassing device 120 is configured to detect current direction of which the mobile phone 100 is oriented, with respect to earth's North Pole; a map within the mobile phone 100.

The map may be configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity, wherein the current angle of orientation is used to represent the slanted angle of the slope; using the compassing device 120 to report a reading providing current direction of the mobile phone 100, wherein the current direction of the mobile phone 100 is used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system.

After the central system receives the reading by accelerometer device 110, the reading by the compassing device 120, and the reading by the location detection device 130 to the central system, the central system adds the readings to a map of the given area in relation to the current location; after the central system completes adding the readings to the map, the central system sends the map to the mobile phone 100 when the mobile phone 100 requests for receiving the map; searching for the current direction and the degree of inclination of the slope of current location by the user using the mobile phone 100 at a later time, by referring to the map received from the central system, wherein the mobile phone 100 is being placed at a location away from the current location; a separate GPS device that is configured to report inclination of slopes of current positions, wherein the central system sends the map to the GPS device when a user of the GPS device requests for receiving the map; and the GPS device searches for the current direction and the degree of inclination of the slope of current location by the user using the separate GPS device, by referring to the map received from the central system, wherein the GPS device is being placed at the current location; and a correcting unit within the mobile phone 100, wherein the correcting unit corrects any wrong information of the map received from the central system, when the mobile phone 100 detects a different result from the map.

Further, in yet another example, a system may be provided for measuring inclination of slopes given their locations with respect to fixed directions. In which case, the system may comprise a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, where in the accelerometer device 110 is configured to measure an angle of orientation, wherein the angle represents the current angle of orientation the mobile phone 100 with respect to gravity; a compassing device 120 within the mobile phone 100.

The compassing device 120 may be configured to detect current direction of which the mobile phone 100 is oriented, with respect to earth's North Pole; a map within the mobile phone 100, wherein the map is configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity.

The current angle of orientation is used to represent the slanted angle of the slope; using the compassing device 120 to report a reading providing current direction of the mobile phone 100, wherein the current direction of the mobile phone 100 is used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system, wherein after the central system receives the reading by accelerometer device 110, the reading by the compassing device 120, and the reading by the location detection device 130 to the central system, the central system adds the readings to a map of the given area in relation to the current location.

After the central system completes adding the readings to the map, the central system sends the map to the mobile phone 100 when the mobile phone 100 requests for receiving the map; searching for the current direction and the degree of inclination of the slope of current location by the user using the mobile phone 100 at a later time, by referring to the map received from the central system, wherein the mobile phone 100 is being placed at a location away from the current location; a separate GPS device that is configured to report inclination of slopes of current positions, wherein the central system sends the map to the GPS device when a user of the GPS device requests for receiving the map; and the GPS device searches for the current direction and the degree of inclination of the slope of current location by the user using the separate GPS device, by referring to the map received from the central system, wherein the GPS device is being placed at the current location; and a correcting unit within the mobile phone 100, wherein the correcting unit corrects any wrong information of the map received from the central system, when the mobile phone 100 detects a different result from the map; and wherein any wrong information is detected, the correcting unit sends the different result to the central system to dispute the wrong location.

Implementation of the present invention should not be limited to systems but also methods. In one implementation, a computer-implemented method is disclosed, which comprises sending, by the central system, the map to a GPS device when a user of the GPS device requests for receiving the map. The method further comprises searching, by the GPS device, for the current direction and the degree of inclination of the slope of current location by the user using the separate GPS device, by referring to the map received from the central system, wherein the GPS device is being placed at the current location.

Likewise, other representations of the invention, such as computer-readable storage medium, can be deployed in the present invention. In one example, a computer-readable storage medium may include steps executable on such storage medium, which include sending, by the central system, the map to a GPS device when a user of the GPS device requests for receiving the map. The method further comprises searching, by the GPS device, for the current direction and the degree of inclination of the slope of current location by the user using the separate GPS device, by referring to the map received from the central system, wherein the GPS device is being placed at the current location. The steps may further comprise correcting, by a correcting unit, wrong information of the map received from the central system, when the mobile phone 100 detects a different result from the map.

The above method steps according to embodiments of the invention may be performed by a programmable processor executing a program of instructions to perform functions or steps of the methods by operating based on input data, and by generating output data. Embodiments of the invention may also be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, or in assembly or machine code. The language or code can be a compiled or interpreted language or code. Processors may include general and special purpose microprocessors. A processor receives instructions and data from memories, in particular from read-only memories or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in application-specific integrated circuits (ASICs).

To provide for interaction with a user, aspects of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Although illustrative embodiments have been described herein with reference to the accompanying drawings, it is noted that the invention is not limited to the precise system and method embodiments described herein, and that various other changes and modifications may be affected by one skilled in the art without departing from the scope or spirit of the invention. All such changes and modifications are intended to be included within the scope of the invention as defined by the appended claims. Embodiments of the present invention include a system for measuring inclination of slopes given their locations with respect to fixed directions, comprising a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, wherein the accelerometer device 110 is configured to measure an angle of orientation, wherein the angle represents the current angle of orientation the mobile phone 100 with respect to gravity; a compassing device 120 within the mobile phone 100, wherein the compassing device 120 is configured to detect current direction of which the mobile phone 100 is oriented, with respect to earth's North Pole.

In the system, a map within the mobile phone 100 is included. The map is configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity, wherein the current angle of orientation is used to represent the slanted angle of the slope; using the compassing device 120 to report a reading providing current direction of the mobile phone 100.

The current direction of the mobile phone 100 may be used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system, wherein after the central system receives the reading by accelerometer device 110, the reading by the compassing device 120, and the reading by the location detection device 130 to the central system, the central system adds the readings to a map of the given area in relation to the current location; after the central system completes adding the readings to the map, the central system sends the map to the mobile phone 100 when the mobile phone 100 requests for receiving the map; and searching for the current direction and the degree of inclination of the slope of current location by the user using the mobile phone 100 at a later time, by referring to the map received from the central system, wherein the mobile phone 100 is being placed at a location away from the current location.

In one implementation, a system is provided to measure inclination of slopes given their locations with respect to fixed directions. The system comprises a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, where in the accelerometer device 110 is configured to measure an angle of orientation, wherein the angle represents the current angle of orientation the mobile phone 100 with respect to gravity; a compassing device 120 within the mobile phone 100, wherein the compassing device 120 is configured to detect current direction of which the mobile phone 100 is oriented, with respect to earth's North Pole; a map within the mobile phone 100, wherein the map is configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity.

The current angle of orientation may be used to represent the slanted angle of the slope; using the compassing device 120 to report a reading providing current direction of the mobile phone 100, wherein the current direction of the mobile phone 100 is used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system.

After the central system receives the reading by accelerometer device 110, the reading by the compassing device 120, and the reading by the location detection device 130 to the central system, the central system adds the readings to a map of the given area in relation to the current location; after the central system completes adding the readings to the map, the central system sends the map to the mobile phone 100 when the mobile phone 100 requests for receiving the map; searching for the current direction and the degree of inclination of the slope of current location by the user using the mobile phone 100 at a later time, by referring to the map received from the central system, wherein the mobile phone 100 is being placed at a location away from the current location; and a separate GPS device that is configured to report inclination of slopes of current positions, wherein the central system sends the map to the GPS device when a user of the GPS device requests for receiving the map; and the GPS device searches for the current direction and the degree of inclination of the slope of current location by the user using the separate GPS device, by referring to the map received from the central system, wherein the GPS device is being placed at the current location.

In another implementation, a system is provided, which comprises a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, where in the accelerometer device 110 is configured to measure an angle of orientation, wherein the angle represents the current angle of orientation the mobile phone 100 with respect to gravity; a compassing device 120 within the mobile phone 100, wherein the compassing device 120 is configured to detect current direction of which the mobile phone 100 is oriented, with respect to earth's North Pole; a map within the mobile phone 100.

The map may be configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity, wherein the current angle of orientation is used to represent the slanted angle of the slope; using the compassing device 120 to report a reading providing current direction of the mobile phone 100, wherein the current direction of the mobile phone 100 is used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system.

After the central system receives the reading by accelerometer device 110, the reading by the compassing device 120, and the reading by the location detection device 130 to the central system, the central system adds the readings to a map of the given area in relation to the current location; after the central system completes adding the readings to the map, the central system sends the map to the mobile phone 100 when the mobile phone 100 requests for receiving the map; searching for the current direction and the degree of inclination of the slope of current location by the user using the mobile phone 100 at a later time, by referring to the map received from the central system, wherein the mobile phone 100 is being placed at a location away from the current location; a separate GPS device that is configured to report inclination of slopes of current positions, wherein the central system sends the map to the GPS device when a user of the GPS device requests for receiving the map; and the GPS device searches for the current direction and the degree of inclination of the slope of current location by the user using the separate GPS device, by referring to the map received from the central system, wherein the GPS device is being placed at the current location; and a correcting unit within the mobile phone 100, wherein the correcting unit corrects any wrong information of the map received from the central system, when the mobile phone 100 detects a different result from the map.

Further, in yet another example, a system may be provided for measuring inclination of slopes given their locations with respect to fixed directions. In which case, the system may comprise a central system that manages maps including information of slope inclination of a given area; a mobile phone 100 with a lower housing that allows the mobile phone 100 standing without human support; a location detection device 130 within the mobile phone 100, wherein the location detection device 130 detects current location of the mobile phone 100; an accelerometer device 110 within the mobile phone 100, where in the accelerometer device 110 is configured to measure an angle of orientation, wherein the angle represents the current angle of orientation the mobile phone 100 with respect to gravity; a compassing device 120 within the mobile phone 100.

The compassing device 120 may be configured to detect current direction of which the mobile phone 100 is oriented, with respect to earth's North Pole; a map within the mobile phone 100, wherein the map is configured to construct inclination of slopes given their locations with respect to fixed directions; a processor within the mobile phone 100; a memory within the mobile phone 100 that stores instructions that are executed by the processor to perform a method, wherein the method comprises measuring inclination of the slope by placing the mobile phone 100 on the lower housing that is sitting on a slope, wherein the slope is slanted at a slanted angle with respect to earth horizon; using the accelerometer device 110 to report a reading providing the current angle of orientation of the mobile phone 100 with respect to the gravity.

The current angle of orientation is used to represent the slanted angle of the slope; using the compassing device 120 to report a reading providing current direction of the mobile phone 100, wherein the current direction of the mobile phone 100 is used to represent the direction where the slope is slanted at; using the location detection device 130 to detect a reading providing the current location of the mobile phone 100; combining the reading by accelerometer device 110, the reading by the compassing device 120, and the reading by the location detection device 130, in order to form an attribute to represent inclination of the slope of the current location; in order to report the inclination of the slope of the current location, sending the reading by accelerometer device 110, the reading by the compassing device 120, and the reading by the location detection device 130 to the central system, wherein after the central system receives the reading by accelerometer device 110, the reading by the compassing device 120, and the reading by the location detection device 130 to the central system, the central system adds the readings to a map of the given area in relation to the current location.

After the central system completes adding the readings to the map, the central system sends the map to the mobile phone 100 when the mobile phone 100 requests for receiving the map; searching for the current direction and the degree of inclination of the slope of current location by the user using the mobile phone 100 at a later time, by referring to the map received from the central system, wherein the mobile phone 100 is being placed at a location away from the current location; a separate GPS device that is configured to report inclination of slopes of current positions, wherein the central system sends the map to the GPS device when a user of the GPS device requests for receiving the map; and the GPS device searches for the current direction and the degree of inclination of the slope of current location by the user using the separate GPS device, by referring to the map received from the central system, wherein the GPS device is being placed at the current location; and a correcting unit within the mobile phone 100, wherein the correcting unit corrects any wrong information of the map received from the central system, when the mobile phone 100 detects a different result from the map; and wherein any wrong information is detected, the correcting unit sends the different result to the central system to dispute the wrong location.

Implementation of the present invention should not be limited to systems but also methods. In one implementation, a computer-implemented method is disclosed, which comprises sending, by the central system, the map to a GPS device when a user of the GPS device requests for receiving the map. The method further comprises searching, by the GPS device, for the current direction and the degree of inclination of the slope of current location by the user using the separate GPS device, by referring to the map received from the central system, wherein the GPS device is being placed at the current location.

Likewise, other representations of the invention, such as computer-readable storage medium, can be deployed in the present invention. In one example, a computer-readable storage medium may include steps executable on such storage medium, which include sending, by the central system, the map to a GPS device when a user of the GPS device requests for receiving the map. The method further comprises searching, by the GPS device, for the current direction and the degree of inclination of the slope of current location by the user using the separate GPS device, by referring to the map received from the central system, wherein the GPS device is being placed at the current location. The steps may further comprise correcting, by a correcting unit, wrong information of the map received from the central system, when the mobile phone 100 detects a different result from the map.

The above method steps according to embodiments of the invention may be performed by a programmable processor executing a program of instructions to perform functions or steps of the methods by operating based on input data, and by generating output data. Embodiments of the invention may also be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, or in assembly or machine code. The language or code can be a compiled or interpreted language or code. Processors may include general and special purpose microprocessors. A processor receives instructions and data from memories, in particular from read-only memories or random access memories. A computer may include one or more mass storage devices for storing data; such devices may include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as internal hard disks and removable disks; magneto-optical disks; and CD-ROM disks. Any of the foregoing can be supplemented by or incorporated in application-specific integrated circuits (ASICs).

To provide for interaction with a user, aspects of the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical or text user interface through which computer programs interact with users.

A computer may include a processor, memory coupled to the processor, a hard drive controller, a video controller and an input/output controller coupled to the processor by a processor bus. The hard drive controller is coupled to a hard disk drive suitable for storing executable computer programs, including programs embodying the present technique. The I/O controller is coupled by means of an I/O bus to an I/O interface. The I/O interface receives and transmits in analogue or digital form over at least one communication link. Such a communication link may be a serial link, a parallel link, local area network, or wireless link (e.g., an RF communication link). A display is coupled to an interface, which is coupled to an I/O bus. A keyboard and pointing device are also coupled to the I/O bus. Alternatively, separate buses may be used for the keyboard pointing device and I/O interface.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations include software, but systems and methods consistent with the present invention may be implemented as a combination of hardware and software or in hardware alone. Examples of hardware include computing or processing systems, including personal computers, servers, laptops, mainframes, micro-processors and the like. Additionally, although aspects of the invention are described for being stored in memory, one skilled in the art will appreciate that these aspects can also be stored on other types of computer-readable media, such as secondary storage devices, for example, hard disks, floppy disks, or CD-ROM, the Internet or other propagation medium, or other forms of RAM or ROM.

Although illustrative embodiments have been described herein with reference to the accompanying drawings, it is noted that the invention is not limited to the precise system and method embodiments described herein, and that various other changes and modifications may be affected by one skilled in the art without departing from the scope or spirit of the invention. All such changes and modifications are intended to be included within the scope of the invention as defined by the appended claims.

While the invention has been shown and described with reference to particular embodiments thereof, it will be understood by those skilled in the art that the invention can be practiced, with modification, in other environments. For example, although the invention described above can be conveniently implemented in a general purpose computer selectively reconfigured or activated by software, those skilled in the art would recognize that the invention could be carried out in hardware, in firmware or in any combination of software, firmware or hardware including a special purpose apparatus specifically designed to perform the described invention. Therefore, changes in form and detail may be made therein without departing from the spirit and scope of the invention as set forth in the accompanying claims.

What is claimed is:

1. A system for measuring inclination of slopes given their locations with respect to fixed directions, comprising:
a central system that manages maps including information of slope inclination of a given area;
a mobile phone with a lower housing that allows the mobile phone standing without human support;
a location detection device within the mobile phone, wherein:
the location detection device detects current location of the mobile phone;
an accelerometer device within the mobile phone, where in the accelerometer device is configured to:
measure an angle of orientation, wherein the angle represents the current angle of orientation the mobile phone with respect to gravity;
a compassing device within the mobile phone, wherein the compassing device is configured to detect current direction of which the mobile phone is oriented, with respect to earth's North Pole;
a map within the mobile phone, wherein the map is configured to construct inclination of slopes given their locations with respect to fixed directions;
a processor within the mobile phone; and
a memory within the mobile phone that stores instructions that are executed by the processor to perform a method, wherein the method comprises:
measuring inclination of the slope by placing the mobile phone on the lower housing that is sitting on a slope, wherein the slope is slanted at a slanted angle with respect to earth horizon;
using the accelerometer device to report a reading providing the current angle of orientation of the mobile phone with respect to the gravity, wherein the current angle of orientation is used to represent the slanted angle of the slope;
using the compassing device to report a reading providing current direction of the mobile phone, wherein the current direction of the mobile phone is used to represent the direction where the slope is slanted at;
using the location detection device to detect a reading providing the current location of the mobile phone;
combining the reading by accelerometer device, the reading by the compassing device, and the reading by the location detection device, in order to form an attribute to represent inclination of the slope of the current location;
in order to report the inclination of the slope of the current location, sending the reading by accelerometer device, the reading by the compassing device, and the reading by the location detection device to the central system, wherein:
after the central system receives the reading by accelerometer device, the reading by the compassing device, and the reading by the location detection device to the central system, the central system adds the readings to a map of the given area in relation to the current location; and
after the central system completes adding the readings to the map, the central system sends the map to the mobile phone when the mobile phone requests for receiving the map.

2. The system of claim 1, further comprising a separate GPS device that is configured to report inclination of slopes of current positions, wherein the central system sends the map to the GPS device when a user of the GPS device requests for receiving the map; and the GPS device searches for the current direction and the degree of inclination of the slope of current location by the user using the separate GPS device, by referring to the map received from the central system, wherein the GPS device is being placed at the current location.

3. The system of claim 2, further comprising a correcting unit within the mobile phone, wherein the correcting unit corrects any wrong information of the map received from the central system, when the mobile phone detects a different result from the map.

4. The system of claim 3, wherein the correcting unit within the mobile phone, when wrong information is detected, the correcting unit sends the different result to the central system to dispute the wrong location.

5. A computer-implemented method, comprising:
measuring inclination of a slope by placing a mobile phone on a lower housing that is sitting on a slope, wherein the slope is slanted at a slanted angle with respect to earth horizon;
using an accelerometer device to report a reading providing current angle of orientation of the mobile phone with respect to gravity, wherein the current angle of orientation is used to represent a slanted angle of the slope;
using a compassing device to report a reading providing current direction of the mobile phone, wherein the current direction of the mobile phone is used to represent a direction where the slope is slanted at;
using a location detection device to detect a reading providing the current location of the mobile phone;
combining the reading by accelerometer device, the reading by the compassing device, and the reading by the location detection device, in order to form an attribute to represent inclination of the slope of the current location;
in order to report the inclination of the slope of the current location, sending the reading by accelerometer device, the reading by the compassing device, and the reading by the location detection device to the central system;
after a central system receives the reading by accelerometer device, the reading by the compassing device, and the reading by the location detection device to the central system, adding the readings to a map of the given area in relation to the current location; and
after the central system completes adding the readings to the map, sending the map to the mobile phone when the mobile phone requests for receiving the map.

6. A system for measuring inclination of slopes given their locations with respect to fixed directions, comprising:
a processor; and
a memory storing executable instructions that cause the process a method, the method comprising:
measuring inclination of a slope by placing a mobile phone on a lower housing that is sitting on a slope, wherein the slope is slanted at a slanted angle with respect to earth horizon;
using an accelerometer device to report a reading providing current angle of orientation of the mobile phone with respect to gravity, wherein the current angle of orientation is used to represent a slanted angle of the slope;
using a compassing device to report a reading providing current direction of the mobile phone, wherein the current direction of the mobile phone is used to represent a direction where the slope is slanted at;
using a location detection device to detect a reading providing the current location of the mobile phone;
combining the reading by accelerometer device, the reading by the compassing device, and the reading by the location detection device, in order to form an attribute to represent inclination of the slope of the current location;
in order to report the inclination of the slope of the current location, sending the reading by accelerometer device, the reading by the compassing device, and the reading by the location detection device to the central system;
after a central system receives the reading by accelerometer device, the reading by the compassing device, and the reading by the location detection device to the central system, adding the readings to a map of the given area in relation to the current location; and
after the central system completes adding the readings to the map, sending the map to the mobile phone when the mobile phone requests for receiving the map.

7. The method of claim 5, wherein the method further comprises:
sending, by the central system, the map to a GPS device when a user of the GPS device requests for receiving the map; and
searching, by the GPS device, for the current direction and the degree of inclination of the slope of current location by the user using the separate GPS device, by referring to the map received from the central system, wherein the GPS device is being placed at the current location.

8. The method of claim 6, wherein the method further comprises correcting, by a correcting unit, wrong information of the map received from the central system, when the mobile phone detects a different result from the map.

9. The method of claim 8, wherein the correcting unit sends the different result to the central system to dispute the wrong location when the wrong information is detected.
